(19) United States
(12) Patent Application Publication
(10) Pub. No.: US 2023/0237884 A1
(43) Pub. Date: Jul. 27, 2023

(54) Self-Service Terminal Device

(71) Applicant: Eflyn Electronics Ltd., Buena Park, CA (US)

(72) Inventors: Rashid Qadri, Buena Park, CA (US); Dawar Rashid, Buena Park, CA (US)

(73) Assignee: Eflyn Electronics Ltd., Buena Park, CA (US)

(21) Appl. No.: 18/157,865

(22) Filed: Jan. 23, 2023

(30) Foreign Application Priority Data
Jan. 24, 2022 (CN) 307430649

(51) Int. Cl. G07F 19/00

(52) U.S. Cl. CPC G07F 19/205; G07F 19/207; G07F 19/206

(57) ABSTRACT

The utility model belongs to the technical field of outdoor self-service equipment and offers complete self-service terminal equipment, an IP-55 rated housing, a front plate assembly installed on the front of the housing, which has the outdoor rated printer, payment devices, and a scanner. This front plate assembly makes it easy to change the pinpad devices according to the customer's needs. An optional detachable vandal door is also available to protect the investment after hours. It's a lightweight 6-7 kgs door that can be attached and detached easily.

### CROSS-REFERENCES TO RELATED APPLICATIONS

This Non-Provisional Utility Patent application claims the benefit of and priority to Chinese Patent Application Serial No. CN307430649, filed Jan. 24, 2022, entitled “A Self-Service Terminal Device,” the entire contents of which is hereby incorporated herein by reference.

### TECHNICAL FIELD

The utility model belongs to the technical field of self-service equipment, particularly unattended outdoor self-service terminal equipment.

### BACKGROUND

With the popularity of the Internet and the promotion of electronic payment methods, the application of self-service is becoming more and more extensive, such as self-service shopping, self-ordering, self-checkout, self-service business processing, etc. Self-service usually requires the use of self-service terminal equipment. These kiosk devices reduce labor costs while providing convenience and saving customers time.

However, due to structural defects, the existing self-service terminal equipment has inefficient outdoor-rated interactive touch screens and poor anti-vandalism performance. Especially in the after-hours, stealing devices and property inside the equipment and causing property losses.

Therefore, there is an urgent need for an outdoor self-service terminal device to solve the above problems of the existing self-service terminal device due to structural defects, inefficient interactive touch screens, and poor anti-destructive performance.

### SUMMARY

In order to solve the above-mentioned technical problems, the utility model provides a self-service terminal device, which includes: an IP55-rated outdoor casing with a door opening. Inside there's a microcomputer that is connected to the power supply; a detachable vandal door protective cover is also installed on the front of the housing, and the protective cover is connected to the housing through a lock and closes the cover

Optionally, a machine liftable support frame is fastened to the bottom of the housing

Optionally, the machine lifting of the base frame is controlled by the software application program. The outdoor self-service kiosk also has an optional detachable dolly for easy mobility.

Optionally, a canopy is fastened to the top of the housing, and a camera and day/night censored lights are installed on the bottom of the ceiling. Both the camera and the integrated light are respectively connected to a power supply

Optionally, a wall hanging is fastened on the back of the housing.

Optionally, the human-computer interaction module has a computer and an interactive touch screen connected to the computer, a printer, a scanner, and a payment terminal, the computer is set on the back of the cover, and the interactive screen is set on the upper part of the cover, the printer, the scanner, and the payment terminal are arranged at the lower part of the cover.

Optionally, the interactive screen is an outdoor-level LCD touch screen, the printer is an outdoor IP-55 level printer, the scanner is an outdoor IP-55 level barcode scanner, and the payment terminal is an outdoor IP-55 level password Keypad payment terminal.

Optionally, a speaker is provided on the inner surface of the housing, the speaker is connected to the computer, and the computer controls the speaker to broadcast a sound signal

Optionally, a pickup is provided on the lower part of the cover, the pickup is connected to the computer, and the pickup receives the sound signal and transmits it to the computer.

Optionally, light strips are installed on both sides of the housing, the light strips are connected to a power supply, and the light strips are RGB LED light strips

Compared with the prior art, the utility model has the beneficial effects of:

The self-service terminal equipment provided by the utility model is provided with a protective cover on the housing. When the equipment is not in use, the protective cover is connected to the housing through a lock to close the cover so that the human-computer interaction module is stored in the protective cover so that The interactive screen is not easy to be damaged maliciously, which can improve the anti-sabotage performance of the equipment and reduce the risk of theft of devices and property inside the equipment.

### BRIEF DESCRIPTION OF THE DRAWINGS

FIG. 1 is the three-dimensional structure schematic diagram of the outdoor self-service terminal equipment of the present utility model

FIG. 2 is the schematic diagram of the self-service terminal equipment of the present utility model;

FIG. 3 is a stereoscopic structure diagram of another viewing angle of the self-service terminal device of the present invention;

FIG. 4 is a schematic diagram of the opening state of the protective cover of the self-service terminal device of the present invention;

FIG. 5 is a schematic front view of the self-service terminal device of the present invention;

FIG. 6 is a schematic rear view of the self-service terminal device of the present invention;

FIG. 7 is a schematic diagram of a right-side view of the self-service terminal device of the present invention;

FIG. 8 is a schematic diagram of the three-dimensional structure of the housing of the present invention;

FIG. 9 is a schematic diagram of the three-dimensional structure of the cover of the present invention.

FIG. 10 is a schematic rear view of the cover of the present invention;

FIG. 11 is the schematic diagram of the three-dimensional structure of the connecting frame of the present invention.

Graphic description:
10. Computer;
200. Self-service terminal equipment;
201. Shell;
202, cover body;
203. Touch Screen LCD screen and Tap to Pay;
204. Protective cover
205, removable door hinges pin;
206, removable door hinges seat;
207, removable door hinges cover lock;
208, removable door locks hook;
209, vandal door handle;
210, vandal door hinge pin;
211, vandal door hinge pin;
212, vandal door hinge pin locking pin seat;
213, vandal door hinge pin stop plate;
214, pin hole;
215, cover lock hook;
216. Limit card;
217, connecting frame;
218, lock hook slot;
219, limit hole;
220. Interactive screen;
221. printer;
222. Scanner;
223. Payment terminal;
224. Loudspeaker;
225: Sound Network;
226, pickup;
227. Canopy;
228. Monitor;
229. Integrated lights;
230, supporting frame;
231. mobility device;
232: castors;
233. Regulator;
234: Wall hanging;
235, hanging rod;
236, installation board;
237. RGB Light strip

### DETAILED DESCRIPTION

In order to make the purpose, technical solutions, and advantages of the utility model clearer, the utility model will be further described in detail below in conjunction with the accompanying drawings and embodiments. It should be understood that the specific embodiments described here are only used to explain the utility model and are not intended to limit the utility model.

In the description of the present utility model, it should be noted that the terms “center”, “upper”, “lower”, “left”, “right”, “vertical”, “horizontal”, “inner”, “outer” The orientation or positional relationship indicated by etc. is based on the orientation or positional relationship shown in the drawings, which is only for the convenience of describing the utility model and simplifying the description, rather than indicating or implying that the device or element referred to must have a specific orientation, use a specific The azimuth structure and operation, therefore cannot be construed as limiting the utility.

In addition, in the description of the present utility model, unless otherwise clearly stipulated and limited, the terms “installation”, “connection”, “connection,” and so on should be interpreted in a broad sense; for example, it can be a fixed connection or a detachable connection, or integrated connection; it can be a mechanical connection or electrical connection; it can be a direct connection or an indirect connection through an intermediary, or it can be internal communication between two components, it can be a wireless connection or wired connection. For those of ordinary skill in the art, the specific meanings of the above-mentioned terms in the utility model can be understood in specific situations

In addition, the technical features involved in the different embodiments of the present invention described later can be combined as long as they do not constitute conflicts with each other.

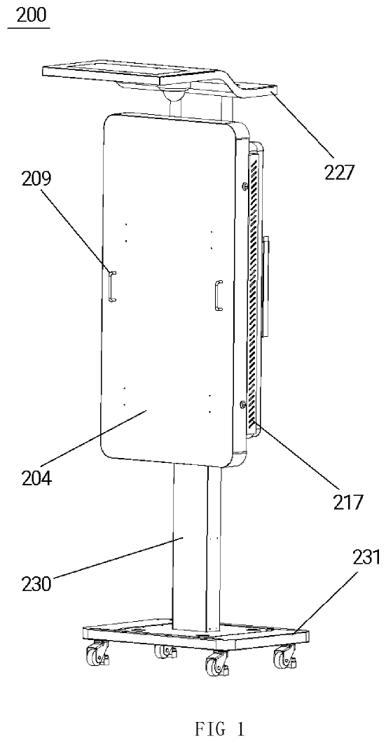

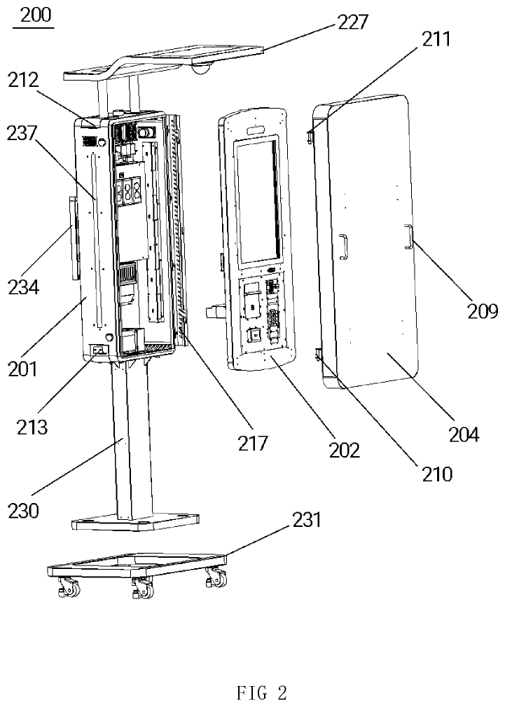

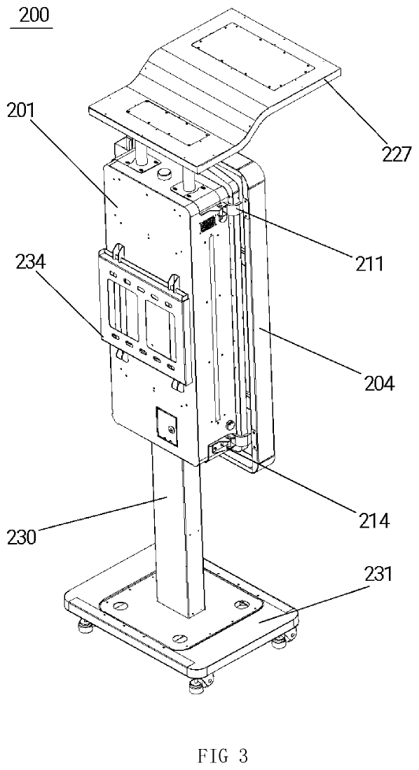

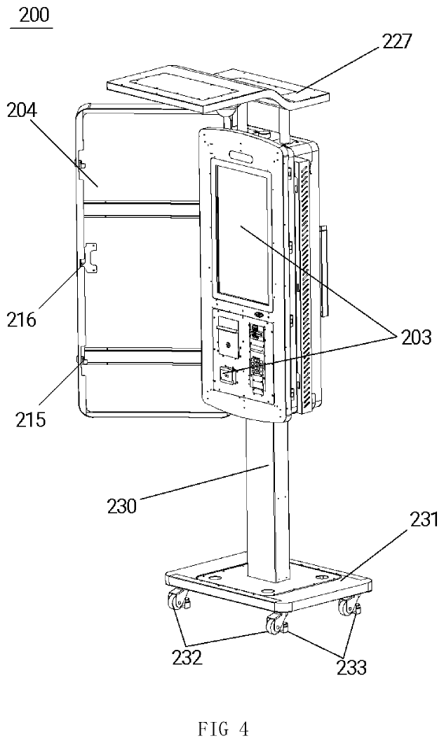

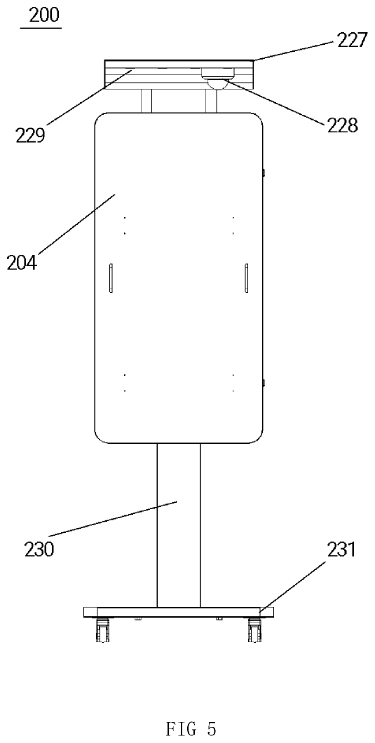

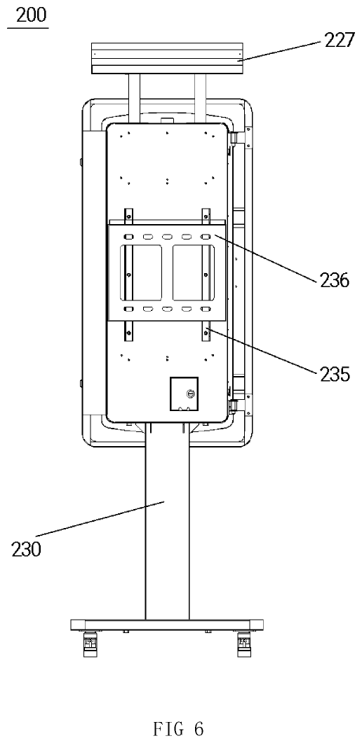

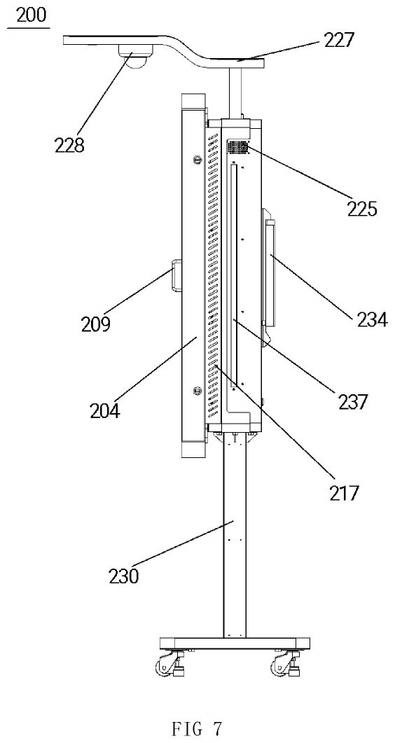

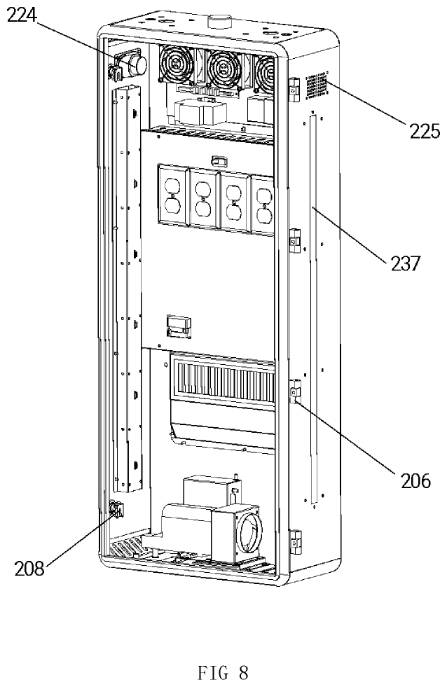

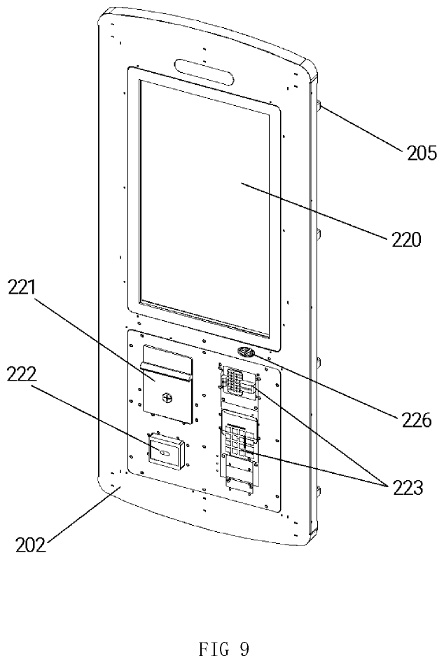

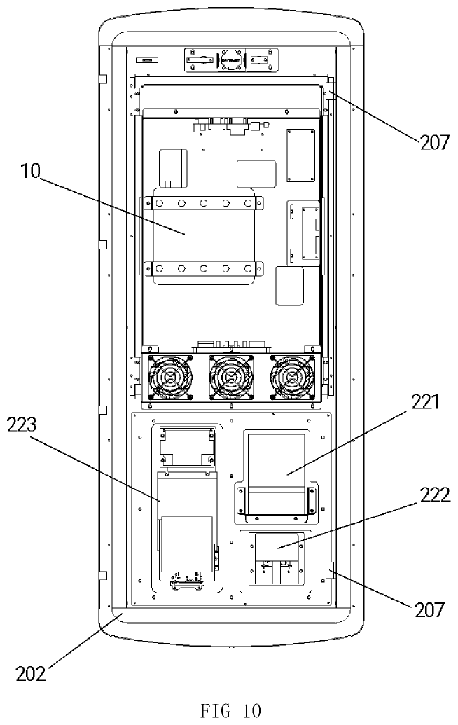

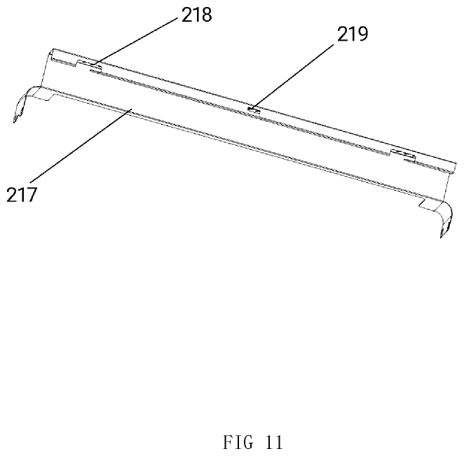

As shown in FIGS. 1-11, the embodiment of the present utility model provides a self-service terminal device 200, which is suitable for self-service in indoor and outdoor environments, and users can view products through the automatic process displayed on the self-service terminal device 200 and services, create orders and make payments. The self-service terminal device 200 includes a rectangular inner hollow shell 201; inside the shell 201, there are several adapters arranged, the front of the shell 201 is installed with an openable cover 202, and the cover 202 is integrated with a man-machine interaction module 203, the human-computer interaction module 203 is connected to the power supply (not shown); the front of the housing 201 is also equipped with a detachable protective cover 204, the protective cover 204 is connected to the housing 201 through a lock and the cover 202 is closed, and the human body The computer interaction module 203 can be hidden inside the protective cover 204 to prevent malicious damage. Specifically, the cover 202 is a rectangular plate structure, and a pin 205 is arranged on one side thereof, and the pin 205 is hinged with a pin seat 206 arranged on the side of the housing 201, so that the cover 202 can be rotated relative to the housing 201 to open and close. Housing 201. A cover lock 207 is arranged on the inner side of the cover 202, and the cover lock 207 extends toward the housing 201. A cover lock 208 is provided on the housing 201 corresponding to the position of the cover lock 207. The cover lock 208 The connecting lock head is installed on the side of the housing 201, and the cover lock hook 208 can be driven and rotated by a key and cooperates with the cover lock 207 to lock or unlock the cover body 202, so as to facilitate the maintenance of the parts on the housing 201 or the cover body 202 or maintenance.

Furthermore, the protective cover 204 is a hollow rectangular structure with an open side, which can be made of stainless steel or steel. Two handles 209 are provided on the outer surface of the protective cover 204 to facilitate the rotation or handling of the protective cover 204. One side of the protective cover 204 is provided with a locking pin 210, and the locking pin 210 is connected to the protective cover 204 through a pin arm 211. A locking pin seat 212 is installed on the housing 201 corresponding to the position of the locking pin 210, and the locking pin seat 212 is formed with a U-shaped opening, wherein the locking pin seat 212 under the housing 201 is equipped with a stop plate 213, a pin hole 214 is formed on the stop plate 213, and the lock pin 210 snaps into the U-shaped opening to cooperate with the lock pin seat 212. After installation, the lock pin 210 under the protective cover 204 snaps into the pin hole 214 to cooperate with the stop plate 213 installed so that the protective cover 204 cannot move down in the vertical direction, Therefore, the protective cover 204 can be positioned on the casing 201, and the protective cover 204 can rotate axially relative to the casing 201. The protective cover 204 is provided with a cover lock hook 215 and a limit card 216 on the opposite side of the locking pin 210. The cover lock hook 215 is provided with a lock head, and the key can drive the cover lock hook 215 to rotate. A connecting frame 217 is fastened on the housing 201, and a locking groove 218 and a limiting hole 219 are formed on the connecting frame 217 corresponding to the position of the cover locking hook 215 and the limiting card 216, and the cover locking hook 215 and the limiting card 216 are respectively fitted with the lock hook groove 218 and the limit hole 219, and the key can drive the cover lock hook 215 to rotate through an angle so as to lock or unlock the protective cover 204. When the self-service terminal device 200 is not in use, the protective cover 204 is installed on the casing 201 to close the cover body 202, so as to protect the human-computer interaction module 203 from being easily damaged by malicious means, improve the anti-destructive performance of the self-service terminal device 200, and reduce the Risk of the devices and property inside the self-service terminal device 200 being stolen.

Further, the human-computer interaction module 203 has a computer 10 and an interactive screen 220 connected to the computer 10, a printer 221, a scanner 222 and a payment terminal 223. The computer 10 is set on the back of the cover 202, and the interactive screen 220 is set on the cover. On the upper part of the cover 202, the printer 221, the scanner 222 and the payment terminal 223 are arranged on the lower part of the cover 202. Specifically, the computer 10 can autonomously control all components or adapters of the terminal device 200 connected to the computer 10 to run properly, and implement communication between local networks. The computer 10 can also run software used by the user on the screen. For example, a set of application program E Suite of the self-service terminal is developed on the computer 10 to support the self-checkout of the self-service terminal. The E Suite software is responsible for running each component of the terminal according to the program to automatically perform tasks such as browsing, ordering, and purchasing. For example, for purchasing tickets, the E Suite application will implement the following steps: 1. Guide the user through the available options; 2. Allow the user to make a selection; 3. Prepare the bill; 4. Process the payment; 5. Print the receipt; Print the voucher. All of the above, all of these can be managed in the cloud through the network, instead of being manually managed on site like the common service terminal device 200.

Furthermore, the interactive screen 220 is an outdoor-grade liquid crystal touch screen through which the user can view the content on the screen, make a selection by touch, and view the result information. The LCD screen is a high-brightness screen, the screen resolution can be as high as 1920*1080p, and the 178/178-degree wide viewing angle displays information and pictures so that users can see the information clearly even under direct sunlight. At the same time, the screen adopts an anti-glare design, which effectively improves visibility and can operate in all weather conditions.

Further, the printer 221 is an outdoor IP-55 printer, and the printer 221 can print information including transaction receipts, admission, purchase orders, coupons, invoices and barcodes. The scanner 222 is an outdoor IP-55 barcode scanner. The scanner 222 mainly scans UPC or QR codes from printed matter or mobile terminals, such as discounts, membership cards, gift cards, purchases, customer identification and management of the machine (such as switching modes or device configuration), etc. The payment terminal 223 is an outdoor IP-55 PIN pad payment terminal, and the PIN pad payment terminal 223 is used to provide a secure payment function for the self-service terminal device 200, which can be completed by clicking, EMV, chip and password, and swiping a card.

Further, a speaker 224 is provided on the inner surface of the casing 201, and the speaker 224 is connected to the computer 10, and the computer 10 controls the speaker 224 to broadcast a sound signal. Specifically, a group of speakers 224 are arranged symmetrically on both sides inside the housing 201, and a sound-transmitting net 225 is formed at the position where the speakers 224 are installed on the housing 201. The speaker 224 is connected to the computer 10 and converts the input signal of the computer 10 into a sound signal and transmits it to the user of the self-service terminal device 200, so as to facilitate human-computer interaction and improve the use function of the human-computer interaction.

In some embodiments, the lower part of the cover 202 is further provided with a pickup 226, the pickup 226 is connected to the computer, and the pickup 226 receives the sound signal and transmits it to the computer 10. Specifically, the sound pickup 226 is installed below the interactive screen 220 and facing the user, so that the user's voice information can be accurately received when the user uses the interactive screen 220 for voice interaction. The pickup 226 can be a microphone, and the setting of the pickup 226 also helps the self-service terminal device 200 realize contactless service through AI technology, improves the use function of the self-service terminal device 200, and satisfies different users or scenarios.

In some embodiments, a ceiling 227 is fastened to the top of the housing 201, and a monitor 228 and an integrated light 229 are installed on the bottom of the ceiling 227, and the monitor 228 and the integrated light 229 are respectively connected to a power source. Specifically, when the self-service terminal device 200 is outdoors, it is preferable that the self-service terminal device 200 is equipped with a ceiling 227, which is installed on the top of the housing 201 and extends outward, so as to provide shade and rain protection for the user. A monitor 228 and an integrated light 229 are set on the ceiling 227. The monitor 228 can monitor the self-service terminal device 200 in real time or can also be connected to the municipal security network monitoring to realize the monitoring of the surrounding environment of the self-service terminal device 200 and reduce the cost of the self-service terminal device 200. monitoring expenditures. The setting of the integrated light 229 can provide lighting sources for the self-service terminal equipment 200 and the monitor 228, to ensure the visual effect of the monitor 228, and also to facilitate the user to operate the self-service terminal equipment 200.

In some embodiments, a liftable support frame 230 is fastened on the bottom of the housing 201, and the use height of the self-service terminal device 200 can be adjusted by adjusting the lift of the support frame 230 to adapt to use heights of different groups. Specifically, the supporting frame 230 can be set as an electric lifting frame or a hydraulic lifting frame. Preferably, the supporting frame 230 adopts the form of electric lifting, and a motor (not shown) is arranged inside the supporting frame 230, and the motor is connected to a power source. In order to control the motor to adjust the use height of the self-service terminal device 200, the motor can be connected to the computer 10 or a switch button, and the user can operate the computer 10 to issue instructions to the motor through the interactive screen 220, thereby controlling the support frame 230 to adjust the use of the self-service terminal device 200 The height can also directly adjust the use height of the self-service terminal device 200 directly through the switch button.

In addition, in order to further improve the practicability of the self-service terminal device 200, especially when the user is driving a motor vehicle, the height of the device 200 can be adjusted without getting off the vehicle, specifically by programming the computer 10, To allow the user to control and adjust the height of the self-service terminal device 200 by running the corresponding software or application program on the mobile phone. Compared with the current self-service terminals on the market that cannot automatically or manually adjust the height of the equipment, the self-service terminal equipment 200 is more advanced and the user experience is better.

Further, in order to facilitate the transfer of the self-service terminal device 200, a walking device 231 is detachably installed on the bottom of the support frame 230. The travel device 231 has a rectangular plate structure and can be fastened to the support frame 230 by bolts. The walking device 231 can be set in the form of a cart, and the wheels 232 are evenly distributed on the bottom of the walking device 231, so as to facilitate the movement of the self-service terminal device 200. An adjuster 233 is provided at the bottom of the walker 231, the adjuster 233 can adjust the balance of the self-service terminal device 200, and the adjuster 233 can also stabilize the self-service terminal device 200 when it touches the ground.

In some embodiments, in order to make the self-service terminal device 200 more widely applicable, a wall hanging 234 is fastened on the back of the housing 201, and the wall hanging 234 can realize the installation of the self-service terminal device 200 on the wall. The structure of the wall hanging 234 can adopt the structural form of double hanging rods 235 and the mounting plate 236. During installation, the mounting plate 236 is first fixed on the wall, and then the self-service terminal device 200 is hung on the mounting plate 236 through the hanging rods 235, which is convenient for installation fast.

In some embodiments, a light strip 237 is installed on both sides of the terminal of the self-service device 200, and the light strip 237 is connected to a power supply. The light strip 237 is an LED light strip 237. The device 200 shows the location and illuminates the surroundings of the kiosk device 200 to facilitate the user's discovery of the kiosk device 200.

The above-mentioned embodiments are only preferred embodiments of the present utility model and cannot be used to limit the scope of protection of the present utility model. The scope of protection required by the utility model.

1. A self-service terminal device, comprising:
a housing, an openable front door, a computer is attached to the front door, and the computer interaction module is connected to a power supply; A detachable protective vandal door cover is also installed on the front of the housing, and the protective cover is connected with the housing through a lock and closes the cover.

2. The self-service terminal device of claim 1, the self-service terminal device also have a hydraulic motor fastened to the bottom of the housing.

3. The self-service terminal device of claim 2, the self-service terminal device wherein the support frame is controlled to raise using the software application. An optional detachable dolly with castors is also available at the bottom for mobility.

4. The self-service terminal device of claim 1, the self-service terminal device also has an optional canopy with accent lights, a day/night sensor, and a security camera. The camera and accent lights are attached to the power supply of the self checkout kiosk.

5. The self-service terminal device of claim 1, the self-service terminal device wherein a wall mount is also fastened to the back of the housing.

6. The self-service terminal device of claim 1, wherein the human-computer interaction module has a computer and an interactive screen connected to the computer, a printer, a scanner, and a payment terminal. The computer is set on the back of the front opening door, the interactive screen is arranged on the upper part of the cover, and the printer, the scanner, and the payment terminal are arranged on the lower part of the front cover door.

7. The self-service terminal device of claim 6, wherein the interactive screen is an outdoor LCD touch screen, the printer is an outdoor IP-55 level printer, and the scanner is an outdoor IP-55 level barcode scanner, the payment terminal is an outdoor IP-55 password keyboard payment terminal.

8. The self-service terminal device of claim 6, the self-service terminal device wherein a speaker is arranged on the inner surface of the casing, the speaker is connected to the computer, and the computer controls the speaker to broadcast sound signals.

9. The self-service terminal device of claim 6, the self-service terminal device is linked to the computer for order processing.

10. The self-service terminal device of claim 1, wherein light strips are installed on both sides of the housing, the light strips are connected to a power supply, and the light strips are RGB LED light strips.
